(19) United States
(12) Patent Application Publication
(10) Pub. No.: US 2012/0296563 A1
(43) Pub. Date: Nov. 22, 2012

(54) Real-Time POI Suggesting Method and Apparatus and Computer Readable Storage Medium with Computer Program to Execute the Method

(75) Inventors: Jason Yi-Bin Lin, Hsinchu County (TW); Chih-Wei Yi, Hsinchu County (TW); Yi-Ta Chuang, New Taipei City (TW); Chia-Sheng Nien, New Taipei City (TW)

(73) Assignee: INSTITUTE FOR INFORMATION INDUSTRY, Taipei (TW)

(21) Appl. No.: 13/222,067

(22) Filed: Aug. 31, 2011

(30) Foreign Application Priority Data
May 20, 2011 (TW) 100117817

(51) Int. Cl. G01C 21/00

(52) U.S. Cl. 701/426; 701/438

(57) ABSTRACT

A real-time point of interest (POI) suggesting method is provided. In the method, present waiting time at several candidate POIs is obtained respectively right when an electronic apparatus is detected leaving an exit of a visited POI. Moving time for heading respectively for the candidate POIs from the visited POI is obtained. A suggested POI is selected from the candidate POIs according to the present waiting time and the moving time. Information of the suggested POI is transmitted to the electronic apparatus. The electronic apparatus outputs the information of the suggested POI. A computer readable storage medium with a computer program to execute the method and a real-time POI suggesting system are also provided.

### RELATED APPLICATIONS

This application claims priority to Taiwan Application Serial Number 100117817, filed May 20, 2011, which is herein incorporated by reference.

### BACKGROUND

1. Technical Field

The presented invention relates to a point of interest (POI) suggesting method and system. More particularly, the presented invention relates to a real-time POI suggesting method, and a system and a computer readable storage medium with a computer program to execute the method.

2. Description of Related Art

Nowadays, the most common way to give travel routes suggestions to tourists is by the reference of the length of waiting lines or waiting time of POIs. Furthermore, such suggestion information is often provided through electronic billboards or electronic communication apparatuses. Queuing networks are often utilized for giving suggestions according to length of waiting lines or waiting time at POIs. Since decisions are often made in steady states while utilizing queuing networks, instant states of waiting lines are unable to be obtained. In addition, providing suggestion information through electronic billboards often leads to large numbers of tourists gathered at the same POIs suggested on the electronic billboards. Moreover, tourists can go to other POIs while waiting in lines virtually through electronic apparatuses. However, in fact, time for waiting in lines is not reduced. Besides, tourists may have to walk for a longer time to reach the POI that they wait in line virtually, such that no benefit is obtained from waiting in line virtually.

### SUMMARY

According to one embodiment of this invention, a real-time POI suggesting method is provided. In the real-time POI suggesting method, when an electronic apparatus leaves an exit of a POI, present waiting time at other POIs and moving time for heading respectively for the other POIs from the present POI is obtained immediately and is used as the basis for suggesting the next POI. The real-time POI suggesting method may take the form of a computer program product stored on a computer-readable storage medium having computer-readable instructions embodied in the medium. In the real-time POI suggesting method, right when an electronic apparatus is detected leaving an exit of a visited POI, present waiting time at several candidate POIs is obtained respectively. Moving time for heading respectively for the candidate POIs from the visited POI is obtained. A suggested POI is selected from the candidate POIs according to the present waiting time and the moving time. Information of the suggested POI is transmitted to the electronic apparatus. The electronic apparatus outputs the information of the suggested POI.

According to another embodiment of this invention, a real-time POI suggesting system is provided. When an electronic apparatus leaves an exit of a POI, the real-time POI suggesting system immediately obtains present waiting time at other POIs and moving time for heading respectively for the other POIs from the present POI immediately and suggests the next POI according to the obtained present waiting time and the obtained moving time. The real-time POI suggesting system includes at least one exit detection device, a first data transmission interface, a wireless data transmission interface and a host terminal. The exit detection device is installed at an exit of a visited POI. When an electronic apparatus is detected leaving the exit, the exit detection device transmits a departing signal. The host terminal includes a connection module, a time obtaining module, a POI selecting module and an information transmitting module. The connection module builds a connection with the exit detection device through the first data transmission interface, and builds a connection with the electronic apparatus through the wireless data transmission interface. Right when the departing signal is received through the first data transmission interface, the time obtaining module obtains present waiting time at several candidate POIs respectively and moving time for heading respectively for the candidate POIs from the visited POI. The POI selecting module selects a suggested POI from the candidate POIs according to the present waiting time and the moving time. The information transmitting module transmits information of the suggested POI to the electronic apparatus. The electronic apparatus outputs the information of the suggested POI.

The present invention can achieve many advantages. When a user leaves the exit of the visited POI carrying an electronic apparatus and wants to head for the next POI, the electronic apparatus can suggest a POI according to the waiting time at other POIs at the time he/she leaves, which can provide the user the most up-to-date suggestion and avoid the user to wait or move for a long time. Moreover, the moving time, which the user brings the electronic apparatus to head for other POIs, is taken into consideration, which can reduce the time for the user to get service at the next POI.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiments, with reference made to the accompanying drawings as follows:

FIG. 1 is a flow diagram of a real-time point of interest suggesting method according to one embodiment of this invention; and

FIG. 2 illustrates a block diagram of a real-time POI suggesting system according to one embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

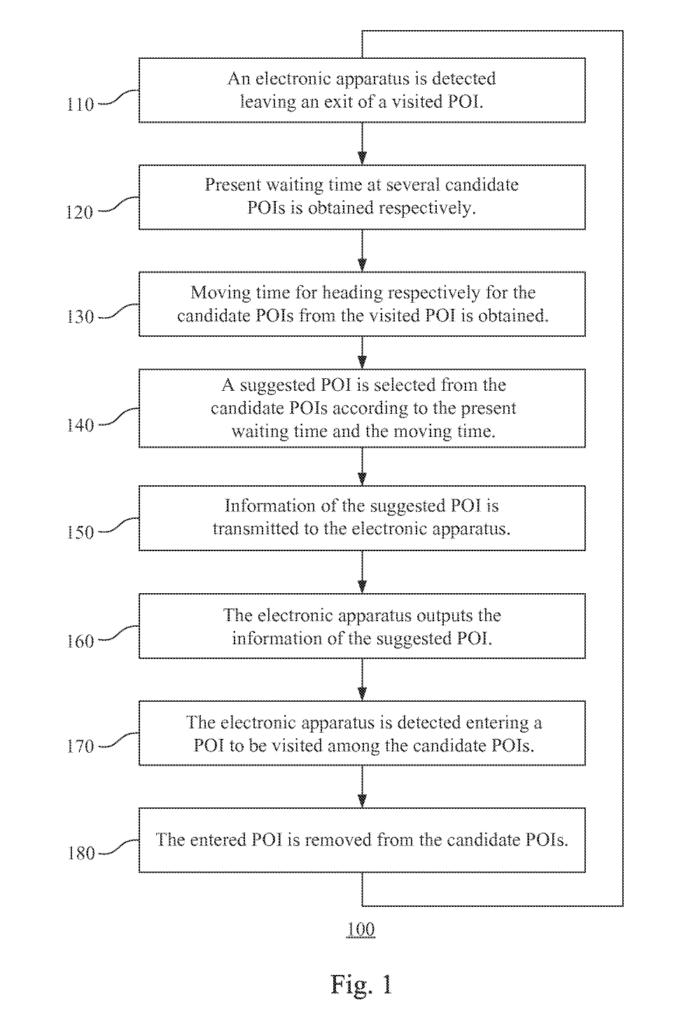

FIG. 1 is a flow diagram of a real-time point of interest suggesting method according to one embodiment of this invention. In the real-time POI suggesting method, when an electronic apparatus leaves an exit of a POI, present waiting time at other POIs and moving time for heading respectively for the other POIs from the present POI is obtained immediately and is used as the basis for suggesting the next POI. The real-time point of interest suggesting method may take the form of a computer program product stored on a computer-readable storage medium having computer-readable instructions embodied in the medium, such that a computer executes the real-time point of interest suggesting method after reading the computer-readable storage medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as static random access memory (SRAM), dynamic random access memory (DRAM), and double data rate random access memory (DDR-RAM); optical storage devices such as compact disc read only memories (CD-ROMs) and digital versatile disc read only memories (DVD-ROMs); and magnetic storage devices such as hard disk drives and floppy disk drives.

The real-time POI suggesting method 100 includes the steps as outlined below.

Immediately when an electronic apparatus is detected leaving an exit of a visited POI (step 110), present waiting time at several candidate POIs is obtained respectively (step 120). The detection in step 110 can be made utilizing a Radio Frequency Identification (RFID) unit, a Bluetooth® unit or any other detection unit installed at the exit of the visited POI. In one embodiment of step 120, present waiting time can be calculated and obtained immediately according to the number of persons in line at each of the candidate POIs. In another embodiment of step 120, present waiting time can be calculated and obtained immediately according to the number of persons in line and time needed for service at each of the candidate POIs. In other embodiments, present waiting time can be obtained (step 120) utilizing other methods, which should not be limited in this disclosure. In addition, when an electronic apparatus is detected leaving an exit of a visited POI (step 110), the pre-stored POIs corresponding to the identification information of the electronic apparatus are obtained, and it is determined if all pre-stored POIs have been visited by the electronic apparatus. When all pre-stored POIs are visited, stop executing the real-time POI suggesting method 100. When not all pre-stored POIs are visited, the real-time POI suggesting method 100 is repeated.

In step 130, moving time for heading respectively for the candidate POIs from the visited POI is obtained.

In step 140, a suggested POI is selected from the candidate POIs according to the present waiting time and the moving time.

In step 150, information of the suggested POI is transmitted to the electronic apparatus.

In step 160, the electronic apparatus outputs the information of the suggested POI. Therefore, when a user leaves the exit of the visited POI carrying the electronic apparatus and wants to head for the next POI, the electronic apparatus can suggest a POI according to the waiting time at other POIs at the time he/she leaves, which can provide the user the most up-to-date suggestion. Moreover, the moving time, in which the user brings the electronic apparatus to head for other POIs, is taken into consideration, which can reduce the time for the user to get service at the next POI.

Furthermore, when the electronic apparatus is detected entering a POI to be visited among the candidate POIs (step 170), the entered POI can be removed from the candidate POIs (step 180). Then, when the leaving of the electronic apparatus is detected (step 110), steps 110-160 can be repeated for the next POI suggestion. As a result, the same POI would not be suggested repeatedly.

In one embodiment of step 140, the candidate POI with the least sum of the present waiting time and the moving time, can be selected as the suggested POI. Hence, step 140 may include calculating estimated time for each of the candidate POIs respectively by adding the present waiting time and the moving time corresponding to each of the candidate POIs. The present waiting time and the moving time are the real-time data obtained from each of the candidate POIs respectively. Then, step 140 may also include the step of selecting the candidate POI, the estimated time of which is the shortest, as the suggested POI. Therefore, the time for the user carrying the electronic apparatus to get next service at next POI can be reduced.

In another embodiment of step 140, several candidate POIs with the least sum of the present waiting time and the moving time, can be filtered, and one of which is selected randomly as the suggested POI. Hence, step 140 may include calculating estimated time for each of the candidate POIs respectively by adding the present waiting time and the moving time corresponding to each of the candidate POIs. The present waiting time and the moving time are the real-time data obtained from each of the candidate POIs respectively. Several candidate POIs, the estimated time of which are the shortest, are filtered. One of the filtered candidate POIs is randomly selected as the suggested POI. As a result, even though users carrying electronic apparatuses leave the exit at the same time, they would not receive the same suggestion, so that overcrowded at a particular POI due to suggesting the same POI to many people at the same time may be avoided.

In another embodiment of step 140, several paths can be formed with the candidate POIs, and the path with the least sum of the present waiting time and the moving time can be selected as a suggested path. Hence, step 140 may include generating several candidate paths formed with the candidate POIs in different sequences. Estimated time for each of the candidate paths is calculated according to the present waiting time and the moving time of the corresponding candidate POIs. The present waiting time and the moving time are the real-time data obtained from each of the candidate POIs respectively. The candidate path, the estimated time of which is the shortest, is selected as the suggested path, and taking the first POI of the suggested path as the suggested POI. Therefore, the time for the user carrying the electronic apparatus to get services at the POIs subsequently visited can be reduced, and also the best suggested POI calculated according to the real-time information of the POIs can be obtained.

In another embodiment of step 140, several paths can be formed with the candidate POIs according to the previous data of the candidate POIs, several paths with the least sum of the present waiting time and the moving time can be filtered, and one of which is selected randomly as the suggested path. Hence, step 140 may include generating several candidate paths formed with the candidate POIs in different sequences. Estimated time for each of the candidate paths is generated according to the present waiting time and the moving time. The present waiting time and the moving time can be the real-time data obtained from each of the candidate POIs respectively. Also, the present waiting time and the moving time can be the historical data obtained from each of the candidate POIs respectively. The candidate paths, the estimated time of which is the shortest, are filtered. One of the filtered candidate paths is randomly selected as a suggested path, and the first POI of the suggested path is taken as the suggested POI. Therefore, the number to obtain real-time data from the POIs can be reduced. Even if users carrying electronic apparatuses leave the exit at the same time, they would not receive the same suggestion, which can avoid the situation where a particular POI is overcrowded in a flash due to suggesting the same POI to many people at the same time. Furthermore, the time for the user carrying the electronic apparatus to get following services can be reduced since the path formed by the subsequent POIs is taken into consideration.

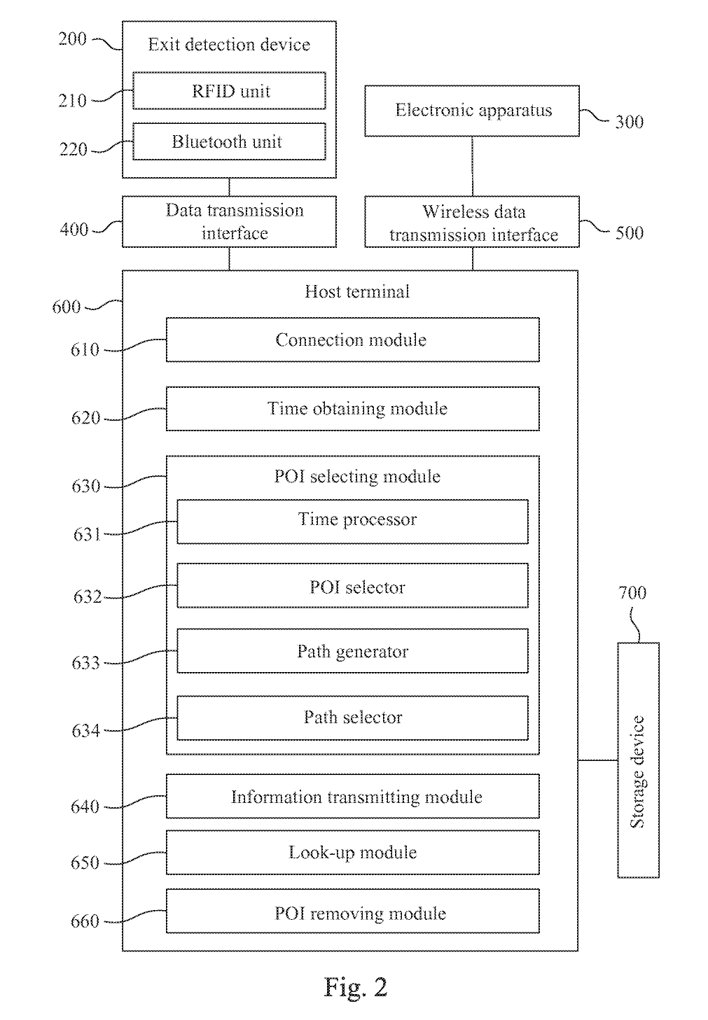

FIG. 2 illustrates a block diagram of a real-time POI suggesting system according to one embodiment of this invention. When an electronic apparatus leaves an exit of a POI, the real-time POI suggesting system obtains present waiting time at other POIs and moving time for heading respectively for the other POIs from the present POI immediately and suggests the next POI according to the obtained present waiting time and the obtained moving time.

The real-time POI suggesting system includes at least one exit detection device 200, a data transmission interface 400, a wireless data transmission interface 500 and a host terminal 600. The data transmission interface 400 may utilize a wired or wireless data transmission protocol to transmit data. The wireless data transmission interface 500 utilizes a wireless data transmission protocol to transmit data. A connection module 610 of the host terminal 600 builds a connection with the exit detection device 200.

When the exit detection device 200 detects that an electronic apparatus 300 leaves the exit of the visited POI (at which the exit detection device 200 is installed), the exit detection device 200 transmits a departing signal to the host terminal 600 through the data transmission interface 400. Several exit detection devices may be pre-installed at several exits of POIs and may be candidates of the exit detection device 200. In addition, the exit detection device 200 may include an RFID unit 210 for utilizing RFID technology to detect the leaving of the electronic apparatus 300. In another embodiment of this invention, the exit detection device 200 may include a Bluetooth® unit. Hence, if signals from the electronic apparatus 300 paired previously are not received, it is determined that the electronic apparatus 300 without signal received from which left the exit of the visited POI. In other embodiment, the exit detection device 200 can utilize other detection technology to detect the leaving of the electronic apparatus 300, which should not be limited in this invention.

The host terminal 600 further includes a time obtaining module 620, a POI selecting module 630 and an information transmitting module 640. Immediately when the departing signal is received through the data transmission interface 400, the time obtaining module 620 obtains present waiting time at several candidate POIs respectively and moving time for heading respectively for the candidate POIs from the visited POI. In one embodiment, the time obtaining module 620 can calculate to obtain present waiting time immediately according to the number of persons in line at each of the candidate POIs. In another embodiment, the time obtaining module 620 can calculate to obtain present waiting time immediately according to the number of persons in line and time needed for service at each of the candidate POIs. In other embodiments, the time obtaining module 620 can obtain present waiting time immediately utilizing other methods, which should not be limited in this disclosure.

In addition, the host terminal 600 may further include a look-up module 650. When the departing signal is received through the data transmission interface 400, the connection module 610 builds a connection with the electronic apparatus 300. The look-up module 650 receives identification information of the electronic apparatus 300 through the wireless data transmission interface 500, and obtains the candidate POIs corresponding to the identification information of the electronic apparatus 300. Furthermore, the real-time POI suggesting system may further include a storage device 700, which builds a connection with the host terminal 600. The storage device 700 stores information of several pre-stored POIs. Hence, the look-up module 650 may look up the storage device 700 according to the identification information of the electronic apparatus 300 to obtain the candidate POIs corresponding to the identification information among the pre-stored POIs. Additionally, when the departing signal is received, the host terminal 600 may further look up according to the identification information of the electronic apparatus 300 to determine if all pre-stored POIs are visited by the electronic apparatus 300. When all pre-stored POIs are visited, the real-time POI suggesting system stops suggesting. When not all pre-stored POIs are visited, the real-time POI suggesting system continually does suggestion.

The POI selecting module 630 selects a suggested POI from the candidate POIs according to the present waiting time and the moving time. The information transmitting module 640 transmits information of the suggested POI to the electronic apparatus 300. The electronic apparatus 300 outputs the information of the suggested POI. Therefore, when a user leaves the exit of the visited POI carrying the electronic apparatus and wants to head for a next POI, the electronic apparatus can suggest a POI according to the waiting time at other POIs at the time he/she leaves, which can provide the user the most fresh suggestion and avoid the user to wait or move for a long time. Moreover, the moving time, which the user brings the electronic apparatus to head for other POIs, is taken into consideration, which can reduce the time for the user to get service at next POI.

The host terminal 600 may further include a POI removing module 660. When the departing signal is received, the POI removing module 660 removes the visited POI from the candidate POIs. As a result, the same POI would not be suggested repeatedly.

In one embodiment of this invention, the POI selecting module 630 may select the candidate POI with the least sum of the present waiting time and the moving time, as the suggested POI. Hence, the POI selecting module may include a time processor 631 and a POI selector 632. The time processor 631 calculates estimated time for each of the candidate POIs respectively by adding the present waiting time and the moving time corresponding to each of the candidate POIs. The present waiting time and the moving time are the real-time data obtained from each of the candidate POIs respectively. The POI selector 632 selects the candidate POI, the estimated time of which is the shortest, as the suggested POI. Therefore, the time for the user carrying the electronic apparatus to get service at the next POI can be reduced.

In another embodiment of this invention, the POI selecting module 630 may filter several candidate POIs with the least sum of the present waiting time and the moving time, and select one of which randomly as the suggested POI. Hence, the time processor 631 can calculate estimated time for each of the candidate POIs respectively by adding the present waiting time and the moving time corresponding to each of the candidate POIs. The present waiting time and the moving time are the real-time data obtained from each of the candidate POIs respectively. The time processor 631 filters the candidate POIs, the estimated time of which are the shortest. The POI selector 632 randomly selects one of the filtered candidate POIs as the suggested POI. As a result, even though multiple users carrying electronic apparatuses leave the exit at the same time, they would not receive the same suggestion, which can avoid overcrowding at a particular POI due to suggesting the same POI to many people at the same time.

In another embodiment of this invention, the POI selecting module 630 may form several paths with the candidate POIs, and select the path with the least sum of the present waiting time and the moving time as a suggested path. Hence, the POI selecting module 630 may further include a path generator 633 and a path selector 634. The path generator 633 generates several candidate paths formed with the candidate POIs in different sequences. The time processor 631 calculates estimated time for each of the candidate paths according to the present waiting time and the moving time. The present waiting time and the moving time are the real-time data obtained from each of the candidate POIs respectively. The path selector 634 randomly selects one of the filtered candidate paths as a suggested path, and takes the first POI of the suggested path as the suggested POI. Therefore, the time for the user carrying the electronic apparatus to get services at the subsequently visited POIs can be reduced.

In another embodiment of this invention, the POI selecting module 630 can form several paths with the candidate POIs according to the previous data of the candidate POIs, filter several paths with the least sum of the present waiting time and the moving time, and select one of which randomly as the suggested path. Hence, the path generator 633 generates several candidate paths formed with the candidate POIs in different sequences. The time processor 633 calculates estimated time for each of the candidate paths according to the present waiting time and the moving time. The present waiting time and the moving time can be the real-time data obtained from each of the candidate POIs respectively. Also, the present waiting time and the moving time can be the historical data obtained from each of the candidate POIs respectively. The path selector 634 randomly selects one of the filtered candidate paths as a suggested path, and takes a first POI of the suggested path as the suggested POI. Therefore, the number to obtain real-time data from the POIs can be reduced. Even though users carrying electronic apparatuses leave the exit at the same time, they would not receive the same suggestion, which can avoid that POI is crowded in a flash due to suggesting the same POI to many people at the same time. Furthermore, the time for the user carrying the electronic apparatus to get following services can be reduced since the path formed by the following POIs is taken into consideration.

The present invention can achieve many advantages. When a user leaves the exit of the visited POI carrying an electronic apparatus and wants to head for a next POI, the electronic apparatus can suggest a POI according to the waiting time at other POIs at the time he/she leaves, which can provide the user the most fresh suggestion and avoid the user to wait or move for a long time. Moreover, the moving time, which the user brings the electronic apparatus to head for other POIs, is taken into consideration, which can reduce the time for the user to get next service at next POI.

Although the present invention has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A real-time point of interest (POI) suggesting method comprising:
obtaining present waiting time at a plurality of candidate POIs respectively immediately when an electronic apparatus is detected leaving an exit of a visited POI;
obtaining moving time for heading respectively for the candidate POIs from the visited POI;
selecting a suggested POI from the candidate POIs according to the present waiting time and the moving time;
transmitting information of the suggested POI to the electronic apparatus; and
asking the electronic apparatus to output the information of the suggested POI.

2. The real-time POI suggesting method of claim 1, wherein the step of selecting the suggested POI from the candidate POIs according to the present waiting time and the moving time comprises:
calculating estimated time for each of the candidate POIs respectively by adding the present waiting time and the moving time corresponding to each of the candidate POIs; and
selecting the candidate POI, the estimated time of which is the shortest, as the suggested POI.

3. The real-time POI suggesting method of claim 1, wherein the step of selecting the suggested POI from the candidate POIs according to the present waiting time and the moving time comprises:
generating a plurality of candidate paths formed with the candidate POIs in different sequences;
calculating estimated time for each of the candidate paths according to the present waiting time and the moving time; and
selecting the candidate path, the estimated time of which is the shortest, as a suggested path, and taking a first POI of the suggested path as the suggested POI.

4. The real-time POI suggesting method of claim 1, wherein the step of selecting the suggested POI from the candidate POIs according to the present waiting time and the moving time comprises:
calculating estimated time for each of the candidate POIs respectively by adding the present waiting time and the moving time corresponding to each of the candidate POIs;
filtering the candidate POIs, the estimated time of which are the shortest; and
randomly selecting one of the filtered candidate POIs as the suggested POI.

5. The real-time POI suggesting method of claim 1, wherein the step of selecting the suggested POI from the candidate POIs according to the present waiting time and the moving time comprises:
generating a plurality of candidate paths formed with the candidate POIs in different sequences;
calculating estimated time for each of the candidate paths according to the present waiting time and the moving time;
filtering the candidate paths, the estimated time of which are the shortest; and
randomly selecting one of the filtered candidate paths as a suggested path, and taking a first POI of the suggested path as the suggested POI.

6. The real-time POI suggesting method of claim 1 further comprising:
when the electronic apparatus is detected entering a POI to be visited among the candidate POIs, removing the entered POI from the candidate POIs.

7. The real-time POI suggesting method of claim 1 further comprising:
receiving identification information of the electronic apparatus; and
obtaining the candidate POIs corresponding to the identification information.

8. The method of claim 1, wherein the detection of the electronic apparatus leaving the exit of the visited POI is made utilizing a Radio Frequency Identification (RFID) unit or a Bluetooth® unit installed at the exit of the visited POI.

9. A computer readable storage medium with a computer program to execute a real-time POI suggesting method, wherein the real-time POI suggesting method comprises:
obtaining present waiting time at a plurality of candidate POIs respectively right when an electronic apparatus is detected leaving an exit of a visited POI;
obtaining moving time for heading respectively for the candidate POIs from the visited POI;
selecting a suggested POI from the candidate POIs according to the present waiting time and the moving time;
transmitting information of the suggested POI to the electronic apparatus; and
recommending the electronic apparatus to output the information of the suggested POI.

10. A real-time POI suggesting system comprising:
at least one exit detection device installed at an exit of a visited POI and for transmitting a departing signal when an electronic apparatus is detected leaving the exit;
a first data transmission interface;
a wireless data transmission interface; and
a host terminal comprising:
a connection module for building a connection with the exit detection device through the first data transmission interface, and building a connection with the electronic apparatus through the wireless data transmission interface;
a time obtaining module for obtaining present waiting time at a plurality of candidate POIs respectively and moving time for heading respectively for the candidate POIs from the visited POI right when the departing signal is received through the first data transmission interface;
a POI selecting module for selecting a suggested POI from the candidate POIs according to the present waiting time and the moving time; and
an information transmitting module for transmitting information of the suggested POI to the electronic apparatus, such that the electronic apparatus outputs the information of the suggested POI.

11. The real-time POI suggesting system of claim 10, wherein the POI selecting module comprises:
a time processor for calculating estimated time for each of the candidate POIs respectively by adding the present waiting time and the moving time corresponding to each of the candidate POIs; and
a POI selector for selecting the candidate POI, the estimated time of which is the shortest, as the suggested POI.

12. The real-time POI suggesting system of claim 10, wherein the POI selecting module comprises:
a path generator for generating a plurality of candidate paths formed with the candidate POIs in different sequences;
a time processor for calculating estimated time for each of the candidate paths according to the present waiting time and the moving time; and
a path selector for selecting the candidate path, the estimated time of which is the shortest, as a suggested path, and taking a first POI of the suggested path as the suggested POI.

13. The real-time POI suggesting system of claim 10, wherein the POI selecting module comprises:
a time processor for calculating estimated time for each of the candidate POIs respectively by adding the present waiting time and the moving time corresponding to each of the candidate POIs, and for filtering the candidate POIs, the estimated time of which are the shortest; and
a POI selector for randomly selecting one of the filtered candidate POIs as the suggested POI.

14. The real-time POI suggesting system of claim 10, wherein the POI selecting module comprises:
a path generator for generating a plurality of candidate paths formed with the candidate POIs in different sequences;
a time processor for calculating estimated time for each of the candidate paths according to the present waiting time and the moving time, and for filtering the candidate paths, the estimated time of which are the shortest; and
a path selector for randomly selecting one of the filtered candidate paths as a suggested path, and taking a first POI of the suggested path as the suggested POI.

15. The real-time POI suggesting system of claim 10, wherein the host terminal further comprises:
a POI removing module, wherein when the electronic apparatus is detected entering a POI to be visited among the candidate POIs, the POI removing module removes the entered POI from the candidate POIs.

16. The real-time POI suggesting system of claim 10, wherein:
the real-time point of interest suggesting system further comprises:
a storage device building connection with the host terminal and for storing information of a plurality of pre-stored POIs;
the host terminal further comprises:
a look-up module for receiving identification information of the electronic apparatus through the wireless data transmission interface, and obtaining the candidate POIs corresponding to the identification information among the pre-stored POIs.

17. The real-time POI suggesting system of claim 10, wherein the exit detection device comprises:
an RFID unit for detecting the leaving of the electronic apparatus utilizing RFID technology.

18. The real-time POI suggesting system of claim 10, wherein the exit detection device comprises:
a Bluetooth® unit, wherein if signals for the electronic apparatus paired previously are not received, it is determined that the electronic apparatus without signal received from which left the exit of the visited POI.
